(19) United States
(12) Patent Application Publication
(10) Pub. No.: US 2008/0189910 A1
(43) Pub. Date: Aug. 14, 2008

(54) HINGE

(76) Inventors: Jia-Hao HSU, Shulin City (TW); An-Di Lu, Shulin City (TW)

Correspondence Address: Rabin & Berdo, P.C., Suite 500, 1101 14th Street, Washington, DC, 20005, US

(21) Appl. No.: 11/674,195

(22) Filed: Feb. 13, 2007

(51) Int. Cl. E05D 7/06

(52) U.S. Cl. 16/387

(57) ABSTRACT

A hinge with a metal injection-molding board is mounted between a cover and a base of an electronic appliance and has a central bracket and a rotating pivoting assembly. The metal injection-molding board is attached securely on an outside surface of the central bracket and extends out of an inside surface of the central bracket. The rotating pivoting assembly connects rotatably to the metal injection-molding board. When the cover pivots relative to the base along longitudinal axis, the rotating pivoting assembly rotates relative to and rubs against the metal injection-molding board so the central bracket is not worn. Because a board made of metal injection molding is strengthened, the metal injection-molding board can bear the abrasion. Therefore, the lifespan of the hinge is effectively lengthened.

### BACKGROUND OF THE INVENTION

1. Field of the Invention

The present invention relates to a hinge mounted between a cover and a base of an electronic appliance, especially to a hinge with a long lifespan.

2. Description of the Prior Arts

Electronic appliances such as notebook computers, cell phones, etc. have a cover, a base and a conventional hinge. The conventional hinge connects the cover to the base along a transverse axis and a longitudinal axis to allow the cover to pivot relative to the base. Because the conventional hinge rotates frequently, components of the conventional hinge rub against each other very often. Therefore, the components of the conventional hinge are easily worn down. Thus, the conventional hinge has short lifespan.

To overcome the shortcomings, the present invention provides a hinge with a long lifespan to mitigate or obviate the aforementioned problems.

### SUMMARY OF THE INVENTION

The main objective of the present invention is to provide a hinge with a metal injection-molding board. The hinge with a metal injection-molding board is mounted between a cover and a base of an electronic appliance and has a central bracket, a pivoting assembly, a pivoting bracket and a rotating pivoting assembly. The pivoting assembly and the pivoting bracket is mounted respectively on the central bracket and connect to the base of the electronic appliance. The metal injection-molding board is attached securely on an outside surface of the central bracket and extends out of an inside surface of the central bracket. The rotating pivoting assembly connects rotatably to the metal injection-molding board. When the cover pivots relative to the base along longitudinal axis, the rotating pivoting assembly rotates relative to and rubs against the metal injection-molding board so the central bracket is not worn. Because a board made of metal injection molding is strengthened, the metal injection-molding board can bear the abrasion. Therefore, the lifespan of the hinge is effectively lengthened.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is another exploded perspective view of the hinge in FIG. 1;

FIG. 4 is a cross-sectional side view of the hinge in FIG. 1;

FIG. 5 is an operational end view of the hinge in FIG. 1 mounted in an electronic appliance; and

FIG. 6 is an exploded perspective view of another embodiment of a hinge in accordance with the present invention.

### DETAILED DESCRIPTION OF THE PREFERRED EMBODIMENTS

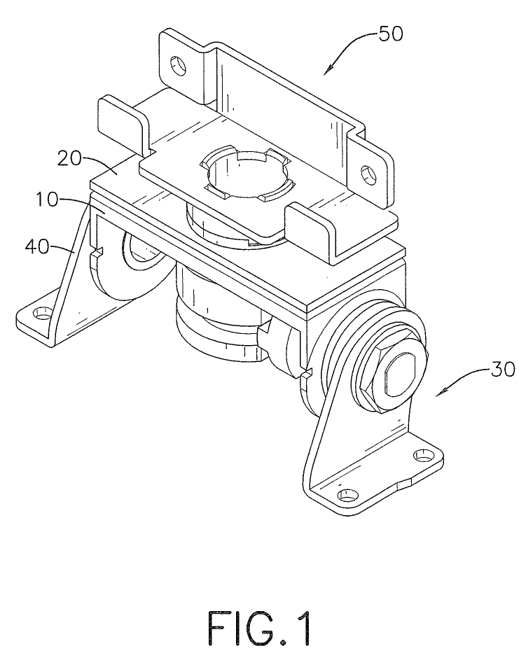

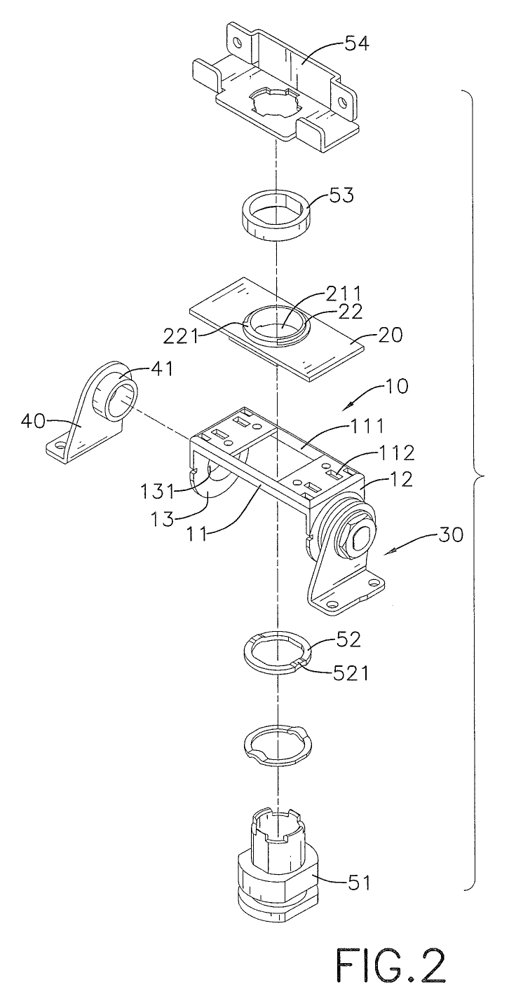

With reference to FIGS. 1 and 2, a hinge in accordance with the present invention comprises a central bracket (10), a metal injection-molding board (20), a tilt pivoting assembly (30), a tilt pivoting bracket (40) and a rotating pivoting assembly (50).

The central bracket (10) comprises a main arm (11), a first wing (12) and a second wing (13).

The main arm (11) has a first end, a second end, an inside surface, an outside surface, a central opening (111) and multiple fastening holes (112). The central opening (111) is formed through the main arm (11). The fastening holes (112) are formed separately through the main arm (11).

The first wing (12) is formed perpendicularly on the first end of the main arm (11) and extends toward the inside surface of the main arm (11).

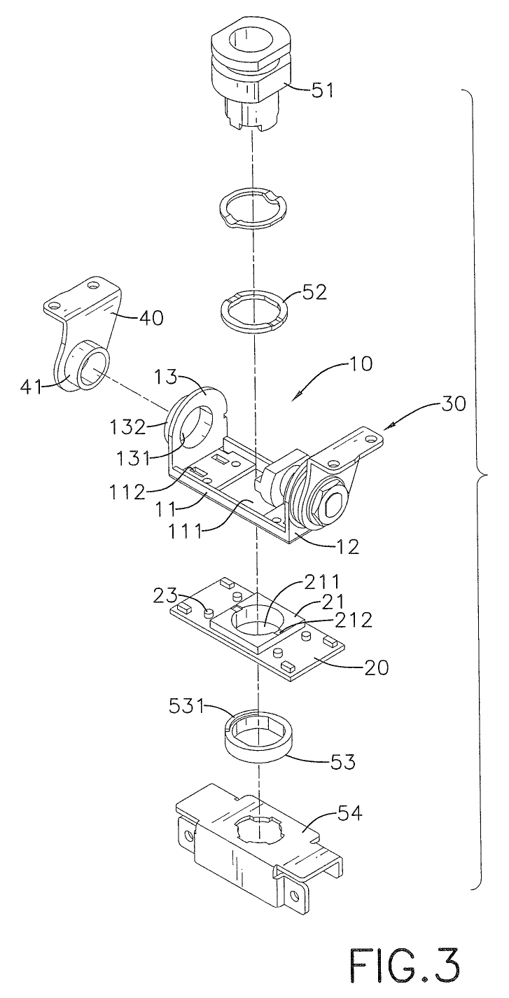

With further reference to FIG. 3, the second wing (13) is formed perpendicularly on the second end of the main arm (11), extends toward the inside surface of the main arm (11) and has an outside surface, a central hole (131) and a mounting sleeve (132). The central hole (131) is formed through the second wing (13). The mounting sleeve (132) is formed on the outside surface of the second wing (13) and is formed around the central hole (131) of the second wing (13).

The metal injection-molding board (20) is attached securely on the outside surface of the main arm (11) and has an inside surface, an outside surface, a central hole (211), a central protrusion (21), at least one positioning detent (212), a flange (22), a limiting protrusion (221) and multiple fastening protrusions (23). The inside surface of the metal injection-molding board (20) faces the outside surface of the main arm (11). The central hole (211) is formed through the metal injection-molding board (20) and aligns with the central opening (111) of the main arm (11). The central protrusion (21) is formed on and extends out of the inside surface of the metal injection-molding board (20) and is formed around the central hole (211) of the metal injection-molding board (20). The at least one positioning detent (212) is formed in the central protrusion (21). The flange (22) is formed on and extends out of outside surface of the metal injection-molding board (20), is formed around the central hole (211) of the metal injection-molding board (20) and has an annular edge. The limiting protrusion (221) is formed radially on the annular edge of the flange (22) of the metal injection-molding board (20). The fastening protrusions (23) are formed on the inside surface of the metal injection-molding board (20) and respectively engage the fastening holes (112) in the main arm (11) of the central bracket (10) to attach the metal injection-molding board (20) securely to the main arm (11).

The tilt pivoting assembly (30) connects pivotally to the first wing (12) of the central bracket (10).

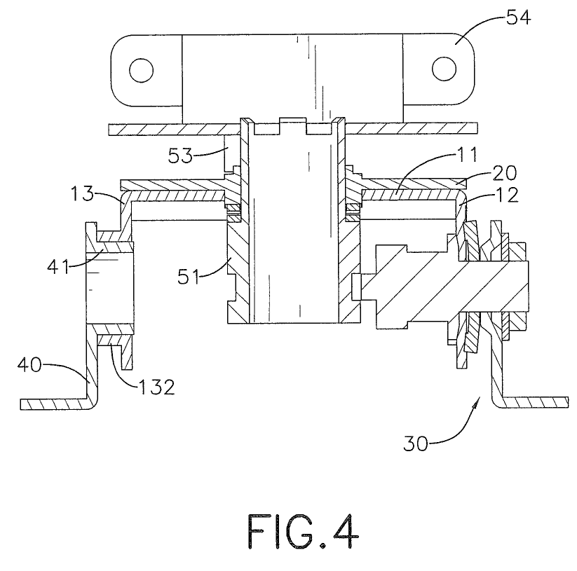

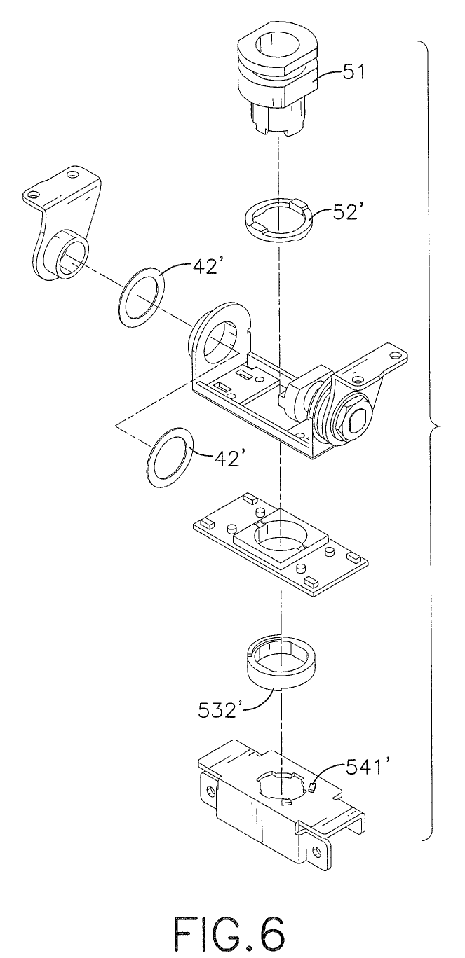

With further reference to FIGS. 4 and 6, the tilt pivoting bracket (40) connects pivotally to the second wing (13) of the central bracket (10) and has a central sleeve (41) and at least one washer (42′). The central sleeve (41) is mounted rotatably in and is held in the mounting sleeve (132) of the second wing (13) of the central bracket (10). The washer (42′) is mounted around the central sleeve (41) to reduce friction.

The rotating pivoting assembly (50) connects pivotally to the metal injection-molding board (20) and comprises a central shaft (51), a positioning spacer (52, 52′), a limiting spacer (53) and a fastening bracket (54). The central shaft (51) connects rotatably to the metal injection-molding board (20) and extends through the central hole (211) of the metal injection-molding board (11). The positioning spacer (52, 52′) is mounted securely on the central shaft (51) and has at least one positioning protrusion (521). The positioning spacer (52′) is a resilient spacer. The at least one positioning protrusion (521) is formed on the positioning spacer (52, 52′) and corresponds to and selectively engages the positioning detent (212) of the metal injection-molding board (20) to hold the positioning spacer (52, 52′) in position. The limiting spacer (53) is mounted securely on the central shaft (51) and has an inside surface, an outside surface, a first limiting protrusion (531) and a second limiting protrusion (532′). The first limiting protrusion (531) is formed axially on the inside surface of the limiting spacer (53) and selectively abuts the limiting protrusion (221) of the metal injection-molding board (20) to limit the rotating angle of the limiting spacer (53). The second limiting protrusion (532′) is formed axially on the outside surface of the limiting spacer (53). The fastening bracket (54) is mounted rotatably around the central shaft (51), is mounted adjacent to the outside surface of the limiting spacer (53) and has at least one limiting protrusion (541′). The limiting protrusion (541′) is formed on the fastening bracket (54) and selectively abuts the second limiting protrusion (532′) of the limiting spacer (53) to limit the rotating angle of the limiting spacer (53).

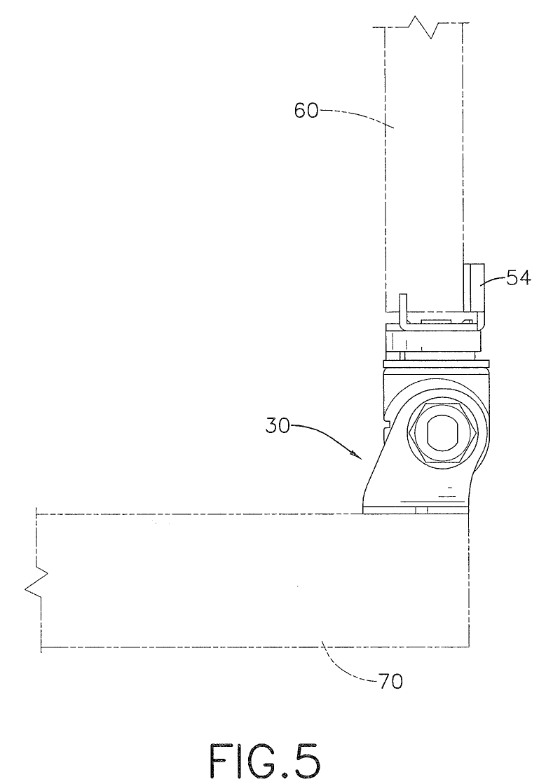

With further reference to FIG. 5, the hinge as described is mounted between a cover (60) and a base (70) of an electronic appliance. The tilt pivoting assembly (30) and the tilt pivoting bracket (40) connects to the base (70). The fastening bracket (54) connects to the cover (60).

When the cover (60) pivots relative to the base (70) along longitudinal axis, the cover (60) rotates the rotating pivoting assembly (50) relative to the metal injection-molding board (20). The rotating pivoting assembly (50) rubs against the metal injection-molding board (20) so the central bracket (10) is not worn. Because a board made of metal injection molding is strengthened, the metal injection-molding board (20) can bear more abrasion. Therefore, the lifespan of the hinge is effectively lengthened.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a central bracket having
a main arm having a first end, a second end, an inside surface, an outside surface and a central opening;
a first wing formed perpendicularly on the first end of the main arm and extending toward the inside surface of the main arm; and
a second wing formed perpendicularly on the second end of the main arm and extending toward the inside surface of the main arm;
a metal injection-molding board attached securely on the outside surface of the main arm and having
an inside surface facing the outside surface of the main arm;
an outside surface;
a central hole formed through the metal injection-molding board and aligning with the central opening of the main arm; and
a central protrusion formed on and extending out of the inside surface of the metal injection-molding board and formed around the central hole;
a tilt pivoting assembly connecting pivotally to the first wing of the central bracket;
a tilt pivoting bracket connecting pivotally to the second wing of the central bracket; and
a rotating pivoting assembly connecting pivotally to the metal injection-molding board.

2. The hinge as claimed in claim 1, wherein
the second wing of the central bracket has
an outside surface;
a central hole formed through the second wing; and
a mounting sleeve formed on the outside surface of the second wing and formed around the central hole of the second wing; and
the tilt pivoting bracket has a central sleeve mounted rotatably in and held in the mounting sleeve of the second wing of the central bracket.

3. The hinge as claimed in claim 2, wherein the rotating pivoting assembly has a central shaft connecting rotatably to the metal injection-molding board and extending through the central hole of the metal injection-molding board; and
a fastening bracket mounted rotatably around the central shaft.

4. The hinge as claimed in claim 3, wherein
the metal injection-molding further has at least one positioning detent formed in the central protrusion; and
the rotating pivoting assembly further has a positioning spacer mounted securely on the central shaft and having at least one positioning protrusion formed on the positioning spacer and corresponding to and selectively engaging the at least one positioning detent of the metal injection-molding board.

5. The hinge as claimed in claim 4, wherein
the metal injection-molding board further has
a flange formed on and extending out of outside surface of the metal injection-molding board, formed around the central hole of the metal injection-molding board and having an annular edge; and
a limiting protrusion formed radially on the annular edge of the flange of the metal injection-molding board; and
the rotating pivoting assembly further has a limiting spacer mounted securely on the central shaft and having
an inside surface;
an outside surface mounted adjacent to the fastening bracket; and
a first limiting protrusion formed axially on the inside surface of the limiting spacer and selectively abutting the limiting protrusion of the metal injection-molding board.

6. The hinge as claimed in claim 5, wherein
the limiting spacer of the rotating pivoting assembly has a second limiting protrusion formed axially on the outside surface of the limiting spacer; and
the fastening bracket of the rotating pivoting assembly having at least one limiting protrusion formed on the fastening bracket and selectively abutting the second limiting protrusion of the limiting spacer.

7. The hinge as claimed in claim 6, wherein
the main arm of the central bracket has multiple fastening holes formed separately through the main arm; and
the metal injection-molding board has multiple fastening protrusions formed on the inside surface of the metal injection-molding board and respectively engaging the fastening holes in the main arm of the central bracket.

8. The hinge as claimed in claim 7, wherein at least one washer is mounted around the central sleeve of the tilt pivoting bracket.

9. The hinge as claimed in clam 8, wherein the positioning spacer of the rotating pivoting assembly is a resilient spacer.
